(19) United States
(12) Patent Application Publication
(10) Pub. No.: US 2024/0284500 A1
(43) Pub. Date: Aug. 22, 2024

(54) LOGICAL CHANNEL RESTRICTION FOR PUSCH TRANSMISSIONS

(71) Applicant: Lenovo (Singapore) Pte. Ltd., New Tech Park (SG)

(72) Inventors: Joachim Löhr, Wiesbaden (DE); Alexander Golitschek, Darmstadt (DE); Hossein Bagheri, Urbana, IL (US)

(21) Appl. No.: 18/571,574

(22) PCT Filed: Jun. 16, 2022
(86) PCT No.: PCT/IB2022/055617

§ 371 Date: Dec. 18, 2023

Related U.S. Application Data
(60) Provisional application No. 63/211,463, filed on Jun. 16, 2021.

(51) Int. Cl. H04W 72/566; H04W 72/04; H04W 72/541

(52) U.S. Cl. CPC H04W 72/569; H04W 72/04; H04W 72/541

(57) ABSTRACT

Various aspects of the present disclosure relate to logical channel restriction for PUSCH transmissions. An apparatus is configured to receive a set of consecutive PUSCH resource allocations and generate MAC PDUs according to the received set of consecutive PUSCH resource allocations by applying a first logical channel restriction configuration during a LCP procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

### CROSS REFERENCE TO RELATED APPLICATIONS

This application claims priority to U.S. Provisional Patent Application No. 63/211,463 entitled “LOGICAL CHANNEL RESTRICTION FOR PUSCH TRANSMISSIONS IN NR-U” and filed on Jun. 16, 2021, for Joachim Lohr, et al., which is incorporated herein by reference.

### FIELD

The subject matter disclosed herein relates generally to wireless communications and more particularly relates to logical channel restriction for physical uplink shared channel (“PUSCH”) transmissions.

### BACKGROUND

Devices/network nodes, such as gNBs, that operate in an unlicensed spectrum may be required to perform a Clear Channel Assessment (“CCA”) e.g., by Listen Before Talk (“LBT,” also referred to as channel sensing) prior to being able to transmit in the unlicensed spectrum. If the device/network node performing LBT does not detect the presence of other signals in the channel, the medium/channel is considered available for transmission.

### BRIEF SUMMARY

Disclosed are solutions for logical channel restriction for PUSCH transmissions. The solutions may be implemented by apparatus, systems, methods, or computer program products.

In one embodiment, a first apparatus includes a transceiver and a processor coupled to the transceiver, the processor configured to cause the apparatus to receive, from a network, a set of consecutive PUSCH resource allocations and generate medium access control (“MAC”) protocol data units (“PDUs”) according to the received set of consecutive PUSCH resource allocations by applying a first logical channel restriction configuration during a logical channel prioritization (“LCP”) procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

In one embodiment, a first method receives, from a network, a set of consecutive PUSCH resource allocations and generates MAC PDUs according to the received set of consecutive PUSCH resource allocations by applying a first logical channel restriction configuration during a LCP procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

In one embodiment, the second apparatus includes a transceiver and a processor coupled to the transceiver, the processor configured to cause the apparatus to transmit, to a UE, a set of consecutive PUSCH resource allocations and receive, from the UE, MAC PDUs that are generated according to the received set of consecutive PUSCH resource allocations by applying a first logical channel restriction configuration during a LCP procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

In one embodiment, the second method transmits, to a UE, a set of consecutive PUSCH resource allocations and receives, from the UE, MAC PDUs that are generated according to the received set of consecutive PUSCH resource allocations by applying a first logical channel restriction configuration during a LCP procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for logical channel restriction for PUSCH transmissions;

FIG. 2 depicts an embodiment of a fixed frame period structure;

FIG. 3 depicts an embodiment of a channel occupancy time (“COT”) initiator for PUSCH transmissions/repetitions;

FIG. 4 depicts another embodiment of a COT initiator for PUSCH transmissions/repetitions;

FIG. 5 is a diagram illustrating one embodiment of a NR protocol stack;

FIG. 6 is a block diagram illustrating one embodiment of a user equipment apparatus that may be used for logical channel restriction for PUSCH transmissions;

FIG. 7 is a block diagram illustrating one embodiment of a network apparatus that may be used for logical channel restriction for PUSCH transmissions;

FIG. 8 is a flowchart diagram illustrating one embodiment of a method for logical channel restriction for PUSCH transmissions;

FIG. 9 is a flowchart diagram illustrating one embodiment of a method for logical channel restriction for PUSCH transmissions.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for logical channel restriction for PUSCH transmissions. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

According to the LCP procedure specified for new radio (“NR”), user equipment (“UE”) multiplexes high priority data (including MAC control elements (“CEs”)) first in a transport block (“TB”) PUSCH allocation. For example, for the case of a multi-transmit time travel (“TTI”)/PUSCH grant this means that the high priority data is placed in the first TB, which is transmitted within the first PUSCH allocation. However, following this principle for a multi-TTI/PUSCH grant when operating in a shared spectrum is likely to result in a situation where UE is not able to transmit high priority data or MAC CE due to listen before talk (“LBT”) failure—or part of the transmission is lost due to a later access to the channel, so that the corresponding TB would not be decodable without further (later) retransmission(s). Because the UE performs LBT to initiate a sequence of uplink (“UL”) transmissions within the multi-TTI/PUSCH grant, the first UL grant is the most probable instance where UL transmission failure may occur due to CCA failure. Therefore, mapping high priority data in the first PUSCH immediately following a CCA/LBT procedure may result in an increased delay for the transmission of the high priority data due to necessary hybrid automatic repeat request (“HARQ”) retransmissions.

For operation in unlicensed spectrum, especially in a semi-static channel access (operation according to Frame-Based Equipment (“FBE”)), downlink and uplink transmissions are allowed after a node such as a gNB or a UE has acquired the shared channel by a successful CCA, following an LBT procedure. The procedures for gNBs and UEs acquiring a COT have been specified in 3GPP NR Rel-16 for both dynamic and semi-static channel access, except for UEs initiating a COT for semi-static channel access which is being specified in 3GPP NR Rel-17.

Determination of ownership of a COT (which device has initiated the COT) at both gNB and UE for an UL transmission is needed to determine:
Whether another UE can send another UL transmission within the COT;
Which idle period (gNB's or UE's) should be respected (e.g., an UL transmission is not allowed within the respected idle period);
Energy detection (“ED”) threshold (which might be different e.g., in case gNB shares UE-COT or UE-initiated COT or might be different if the ED threshold is determined based on UE transmit power, and/or gNB transmit power).

The subject matter herein provides mechanisms to avoid the risk of delaying the transmission of high priority data/MAC CEs due to a LBT failure occurring for the first PUSCH allocation of set of (consecutive) PUSCH allocations.

According to one solution, a UE does not map high priority data/MAC CE(s) to the first x PUSCH allocations (of a set of consecutive PUSCH allocations) immediately following a CCA/LBT procedure. The UE uses a first logical channel (“LCH”) restriction configuration for the first x PUSCH allocations immediately following a CCA/LBT procedure and a second LCH restriction configuration for the remaining PUSCH allocation starting from PUSCH allocation x+1.

In another solution, the UE performs an autonomous retransmission in a subsequent configured grant (“CG”) PUSCH resource thereby ignoring the CG retransmission timer (“CGRT”). The UE is allowed to perform an autonomous retransmission on a consecutive CG PUSCH allocation and ignores the CGRT value if the priority of the data contained in the TB is above a preconfigured threshold.

In certain solutions, the UE considers, for cases that a CG PUSCH immediately follows a CCA/LBT, during HARQ process selection, the priority of the data to be transmitted on the CG PUSCH resource. The UE postpones a high priority (autonomous) retransmission and selects a HARQ process associated with a lower priority initial transmission if the CG PUSCH occasion is immediately following a CCA/LBT procedure.

In one solution, the UE uses a different redundancy version (“RV”) sequence/pattern to be applied to the repetitions of a TB containing high priority data depending on whether the TB is mapped to the first x UL resources/PUSCH allocations immediately following a CCA/LBT procedure. The RV sequence/pattern to be applied to the repetitions of the high priority data (TB) for cases when the TB is mapped to the first x UL resources/PUSCH allocations of a set of consecutive PUSCH allocations is/can be different than that of the case where high priority data is not mapped to the first x UL resource(s)/PUSCH allocations during LCP procedure immediately following a CCA/LBT procedure.

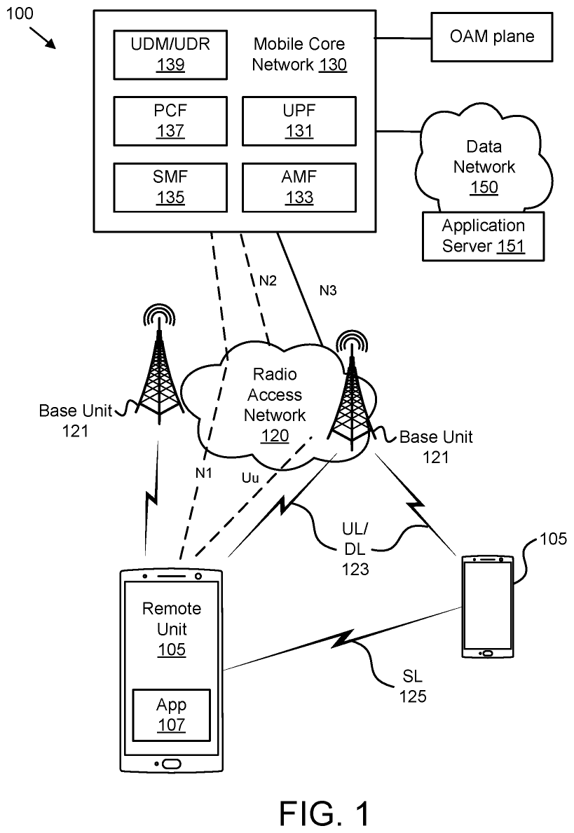

FIG. 1 depicts a wireless communication system 100 supporting logical channel restriction for PUSCH transmissions, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a PDU session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as “‘attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5 GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5 GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”) 136, a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF 136 is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5 GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

The Operations, Administration and Maintenance (“OAM”) 160 is involved with the operating, administering, managing, and maintaining of the system 100. “Operations” encompass automatic monitoring of environment, detecting and determining faults and alerting admins. “Administration” involves collecting performance stats, accounting data for the purpose of billing, capacity planning using Usage data and maintaining system reliability. Administration can also involve maintaining the service databases which are used to determine periodic billing. “Maintenance” involves upgrades, fixes, new feature enablement, backup and restore and monitoring the media health. In certain embodiments, the OAM 160 may also be involved with provisioning, i.e., the setting up of the user accounts, devices, and services.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting serving cells/carriers being configured in an unlicensed spectrum.

In one embodiment, UE/MAC entity applies a first LCH restrictions configuration for the first PUSCH allocation (of a set of multiple, e.g. consecutive, PUSCH allocations) immediately following a CCA/LBT procedure it is ensured that high priority data is not mapped to the first TB/PUSCH allocation of the set of PUSCH allocations. The high priority data would be mapped to the second PUSCH allocation of the set of consecutive PUSCH allocations by applying a second LCH restriction configuration for the second and remaining PUSCH allocations.

In one embodiment, UE does not map high priority data (including high priority MAC CEs) to the first x UL resource(s)/PUSCH allocation(s) during LCP procedure immediately following a CCA/LBT procedure, which is for example the case for the first x UL resource(s) of a channel occupancy for which the UE had to undergo the LBT procedure. Instead, high-priority data is mapped to the (x+1) or later resources.

According to another embodiment, UE performs an autonomous retransmission in a subsequent, e.g. consecutive, CG PUSCH resource thereby ignoring the CGRT (CG-ReTx timer). Accordingly, to one implementation of this embodiment UE is only allowed to perform an autonomous retransmission on a consecutive CG PUSCH allocation and ignoring the CGRT value if the priority of the data contained in the TB is above a preconfigured threshold.

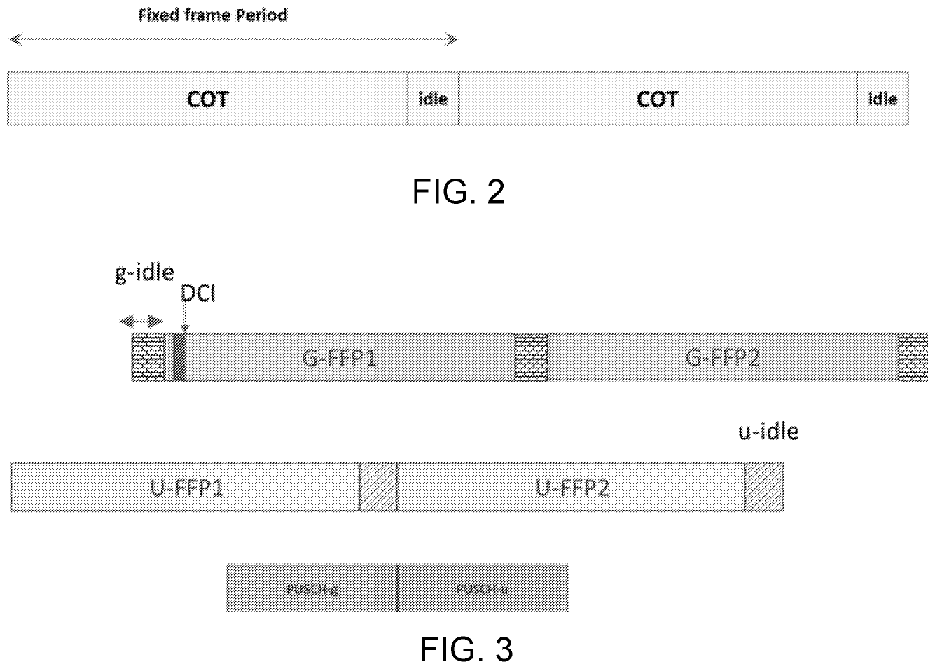

Regarding operation in unlicensed spectrum, as shown in FIG. 2, devices/network nodes such as gNBs operating in unlicensed spectrum may be required to perform a CCA e.g., by LBT prior to being able to transmit in the unlicensed spectrum. If the device/network node performing LBT does not detect the presence of other signals in the channel, the medium/channel is considered available for transmission. In FBE mode of operation, the device/network node performs LBT in an idle period and once acquired the channel/medium, the device/network node can communicate within the non-idle time of a fixed frame period duration (referred to as COT). In current specifications/regulations, the idle time is not shorter than the maximum of 5% of the FFP and 100 microseconds.

Regarding UE initiated channel occupancy (“CO”), a UE can perform channel sensing and access the channel if it senses the channel to be idle. UE initiated CO has not been specified in Rel-16 for FBE-based equipment (semi-static channel access). UE initiated CO could be useful in low-latency applications, wherein having UL data to be sent in configured grant resources is allowed to initiate a CO.

Regarding multi-PUSCH transmission, a single downlink control information (“DCI”) may schedule several TBs, referred to as multi-PUSCH transmission. According to TS 38.214 V16.5.0, for example, if pusch-TimeDomainAllocationListForMultiPUSCH in pusch-Config contains row indicating resource allocation for two to eight contiguous PUSCHs, K2 indicates the slot where UE shall transmit the first PUSCH of the multiple PUSCHs. Each PUSCH has a separate start and length indicator value (“SLIV”) and mapping type. The number of scheduled PUSCHs is signaled by the number of indicated valid SLIVs in the row of the pusch-TimeDomainAllocationListForMultiPUSCH signaled in DCI format 0_1.

Regarding COT initiator determination for CG transmissions, when a configured UL transmission starts after a UE fixed frame period (“FFP”) boundary and ends before the idle period of that UE FFP associated to the UE, if the UE has already initiated the UE FFP, then UE assumes that the configured UL transmission corresponds to UE-initiated COT.

Otherwise, if the transmission is confined within a gNB FFP before the idle period of that gNB FFP, and if the UE has already determined that gNB has initiated that gNB FFP, then UE assumes that the configured UL transmission corresponds to gNB-initiated COT.

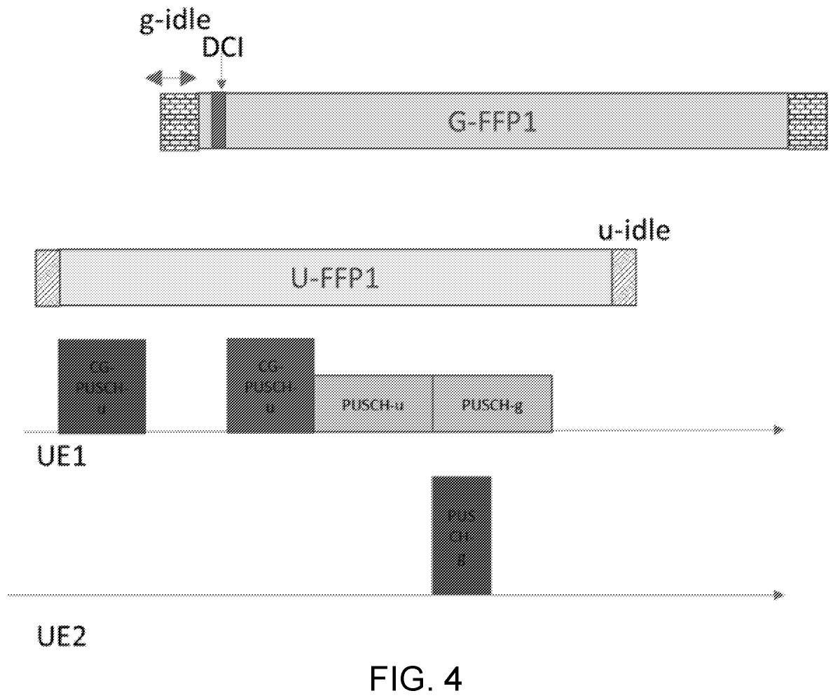

Some benefits of having a different COT initiator for different PUSCH transmissions/repetitions are represented in FIGS. 3 and 4.

In FIGS. 3 and 4, u-FFP refers to a UE-FFP (FFP associated/configured for UE-initiated COT), g-FFP refers to a gNB-FFP (FFP associated/configured for gNB-initiated COT), PUSCH-g refers to a PUSCH transmission that is sent based on gNB being COT initiator, and PUSCH-u refers to a PUSCH transmission that is sent based on UE being COT initiator.

FIG. 3 depicts an embodiment where the DCI schedules PUSCH-g and PUSCH-u. gNB has initiated a COT in G-FFP1 (e.g., to serve other UEs or to schedule the UE). The UE has not initiated a COT in U-FFP1. PUSCH-g is not aligned with a u-FFP boundary and transmitted based on gNB as COT initiator. PUSCH-u can be sent during g-idle (if COT initiator for PUSCH-u is indicated to be the UE) as gNB does not have any other data to initiate a g-COT in G-FFP2. g-idle maybe longer than u-idle and/or the overlap of g-idle and PUSCH-u may also be longer than the overlap of PUSCH-g and u-idle. An LBT/gap may be required between PUSCH-g and PUSCH-u of the UE (e.g., PUSCH-g ends (or PUSCH-g symbols overlapping with u-idle are considered as invalid symbols) prior to u-idle).

FIG. 4 depicts an embodiment where a UE1 has already initiated a COT due to 1^{st} CG-PUSCH transmission (e.g., as CG-PUSCH is aligned with U-FFP1 boundary). gNB knows there is a 2^{nd} CG-PUSCH coming up and would like to schedule UL transmission right after the 2^{nd} CG-PUSCH. The 2^{nd} CG-PUSCH is sent according to UE-COT (e.g., based on the agreed UE behavior for determining the COT initiator in case of CG transmissions as provided in section 2.1.4), and transmitting PUSCH-u according to UE-COT could avoid LBT prior to PUSCH-u transmission; whereas LBT maybe required if PUSCH-u is instead a PUSCH-g as it has to be transmitted assuming g-COT. gNB wants to schedule a PUSCH for UE2, to be able to do that PUSCH-g for UE1 needs to be sent assuming g-COT. An LBT/gap may be required between PUSCH-u and PUSCH-g of UE1.

Regarding channel access procedures for semi-static channel occupancy, channel access procedures based on semi-static channel occupancy are intended for environments where the absence of other technologies is guaranteed e.g., by level of regulations, private premises policies, etc. If a gNB provides UE(s) with higher layer parameters ChannelAccessMode-r16=‘semistatic’by SIB1 or dedicated configuration, a periodic channel occupancy can be initiated by the gNB every Tₓ within every two consecutive radio frames, starting from the even indexed radio frame at i·Tₓ·Tₓ with a maximum channel occupancy time T_{y}=0.95Tₓ, where Tₓ=period Tₓ=Periodin ms, is a higher layer parameter provided in SemiStaticChannelAccessConfig and

$$i ∈ \{ 0 , 1 , … , \frac{20}{{T}_{x}} - 1 \} .$$

In the following procedures in this clause, when a gNB or UE performs sensing for evaluating a channel availability, the sensing is performed at least during a sensing slot duration Tₛₗ=9 us. The corresponding X_{Thresh} adjustment for performing sensing by a gNB or a UE is described in clauses 4.1.5 and 4.2.3 of TS 37.213, respectively.

A channel occupancy initiated by a gNB and shared with UE(s) shall satisfy the following:
The gNB shall transmit a DL transmission burst starting at the beginning of the channel occupancy time immediately after sensing the channel to be idle for at least a sensing slot duration Tₛₗ=9 us. If the channel is sensed to be busy, the gNB shall not perform any transmission during the current period.
The gNB may transmit a DL transmission burst(s) within the channel occupancy time immediately after sensing the channel to be idle for at least a sensing slot duration Tₛₗ=9 us if the gap between the DL transmission burst(s) and any previous transmission burst is more than 16 us.
The gNB may transmit DL transmission burst(s) after UL transmission burst(s) within the channel occupancy time without sensing the channel if the gap between the DL and UL transmission bursts is at most 16 us.
A UE may transmit UL transmission burst(s) after detection of a DL transmission burst(s) within the channel occupancy time as follows:
If the gap between the UL and DL transmission bursts is at most 16 us, the UE may transmit UL transmission burst(s) after a DL transmission burst(s) within the channel occupancy time without sensing the channel.
If the gap between the UL and DL transmission bursts is more than 16 us, the UE may transmit UL transmission burst(s) after a DL transmission burst(s) within the channel occupancy time after sensing the channel to be idle for at least a sensing slot duration Tₛₗ=9 us within a 25 us interval ending immediately before transmission.
The gNB and UEs shall not transmit any transmissions in a set of consecutive symbols for a duration of at least T_{z}=max(0.05Tₓ, 100 us) before the start of the next period.

If a UE fails to access the channel(s) prior to an intended UL transmission to a gNB, Layer 1 notifies higher layers about the channel access failure.

According to the solutions described herein, the term eNB/gNB is used for the base station but it is replaceable by any other radio access node, e.g., BS, eNB, gNB, AP, NR DU/CU, Relay etc. Further the proposed methods are described mainly in the context of 5G NR. However, the proposed solutions/methods are also equally applicable to other mobile communication systems supporting serving cells/carriers being configured in an unlicensed spectrum, LTE mobile wireless or cellular telecommunications system. It should be noted that throughout the document the term “multi-PUSCH transmission” refers to a situation where a device has received one or more DCI (UL grant) or configured uplink grants that each schedule one or more UL resources/allocations/transmissions resulting in UL transmissions in at least two UL resources. It should be further noted that one UL resource may comprise multiple transport blocks/PUSCH(s), e.g., for SU-MIMO transmissions. Further one UL resource may correspond to one slot respectively partial slot or mini-slot.

In one embodiment, there are three uses cases considered throughout this disclosure where the UE may need to perform a CCA/LBT procedure before being allowed to perform a set of consecutive PUSCH transmissions. For those cases, the proposed UE behavior as disclosed in the various embodiment is deemed to be beneficial.

Case 1 is directed to COT initiator changes among different PUSCH transmissions of a multi-PUSCH transmission. The UE receives e.g., a scheduling DCI indicating a first number of consecutive/contiguous PUSCH transmissions of the multi-PUSCH where the transmissions occur in a channel occupancy initiated by a first COT initiator, and a second number of consecutive/contiguous PUSCH transmissions of the multi-PUSCH where the transmissions occur in a channel occupancy initiated by a second COT initiator. An LBT may be required to be performed before the second set of consecutive PUSCH transmissions of the multi-PUSCH according to the second COT initiator, e.g., observing the second initiator's maximum COT duration or idle period. Essentially, the UE maintains a gap and/or performs LBT between each pair of PUSCH transmissions of the multi-PUSCH if the COT initiator is different for the pair of PUSCH transmissions. It should be noted that the PUSCH resources could be also CG PUSCH resources.

Case 2 is directed to COT sharing, e.g., gNB initiated COT is shared with the UE. A channel occupancy is initiated by a gNB and shared with one or more UE(s). A UE may transmit UL transmission burst(s) after detection of a DL transmission burst(s) within the channel occupancy time as follows: If the gap between the UL and DL transmission bursts is more than a predefined gap duration, e.g. 16 us, the UE may transmit UL transmission burst(s) after a DL transmission burst(s) within the channel occupancy time after sensing the channel to be idle for at least a predefined sensing slot duration, e.g. Tₛₗ=9 us within a 25 us interval ending immediately before transmission.

Case 3 is directed to gap(s) between UL transmissions within a COT. A channel occupancy is initiated by a UE. There are gaps between UL transmissions within the COT which are more than a predefined gap duration, e.g., 16 μs.

According to a first embodiment, the UE does not map high priority data to the first x UL resource(s)/PUSCH allocation(s) during LCP procedure immediately following a CCA/LBT procedure, which is for example the case for the first x UL resource(s) of a channel occupancy for which the UE had to undergo the LBT procedure. Instead, high-priority data is mapped to the (x+1) or later resources. For example, if the UE is granted two or more contiguous UL resources in time (regardless of whether as a result of multiple individual UL grants, or multi-TTI grant(s), or CG or a combination of these), then usually for the first such UL resource the UE has to do LBT, while for the second or later such UL resource no additional LBT is necessary if the transmission in the preceding such UL resource was allowed and performed. In case of a multi-PUSCH allocation, the first UL allocation has the highest probability of LBT failure. In one specific implementation of the embodiment x is equal to one, e.g., the UE does not map high priority data to the first UL resource/PUSCH allocation immediately following a CCA/LBT procedure, but instead to the second UL resource/PUSCH allocation following a CCA/LBT procedure.

According to one implementation of the embodiment, the UE does not multiplex any MAC CE(s) to the first x UL allocation(s) immediately following a CCA/LBT procedure. Alternatively, the UE may be allowed to multiplex low-priority MAC CE(s) such as MAC CE for recommended bit rate query and MAC CE for buffer status reporting (“BSR”) included for padding to the first x UL allocation(s) for cases when high priority data mapping is not performed by the UE. Furthermore, the UE may according to a further implementation not multiplex data of LCH(s) having a logical channel priority which is higher than a predetermined threshold to the first x UL allocations. The priority threshold may be preconfigured by higher layer signaling such as radio resource control (“RRC”) signaling or fixed by specification. The LCH(s) having a logical channel priority higher (or equal) to the configured threshold are not considered for the LCP procedure, e.g., LCH restriction according to the priority is performed by the UE for the first x UL allocation(s).

According to one implementation of the embodiment, the UE uses a first LCH restriction configuration for the generation of a TB/LCP procedure for the first x UL resource(s) immediately following a CCA/LBT procedure and a second LCH restriction configuration for the remaining UL resources of the set of allocated UL resources. The first and second LCH restriction configuration may be preconfigured by higher layer signaling such as RRC signaling.

According to one implementation of the embodiment, the UE
uses a first LCH restriction configuration for the generation of a first TB/LCP procedure when the first TB is mapped to the first x UL resource(s)/PUSCH allocation(s) during LCP procedure immediately following a CCA/LBT procedure, and
uses a second LCH restriction configuration for the generation of a second TB/LCP procedure when the second TB is not mapped to the first x UL resource(s)/PUSCH allocation(s) during LCP procedure immediately following a CCA/LBT procedure.

According to one implementation of the embodiment, the UE considers only those logical channels which are delay intolerant, e.g., service can tolerate large transmission delay, for mapping to the first x UL resource(s) immediately following a CCA/LBT procedure. According to one specific implementation RRC configuration for each logical channel is indicating whether data of the corresponding logical channel can be multiplexed to the first x UL resource(s) immediately following a CCA/LBT procedure. This configuration could be done by means of a one-bit flag in the LogicalChannelConfig IE, e.g., RRC configuration, according to one specific implementation.

In yet another embodiment, the UE does not map high priority data to the first PUSCH allocation immediately following a CCA/LBT procedure if the UE is aware that at least one more UL resource/PUSCH allocation is available for transmission immediately after the first such UL resource. For example, if a UE has received grants for two UL transmissions in resource r1 and in resource r2, and the UE needs to undergo the LBT procedure prior to transmitting in resource r1, and LBT succeeds so that the UE can transmit in resource r1, and resource r2 is not immediately following resource r1, then UE shall apply the legacy LCH mapping/restriction behavior respectively LCH prioritization rules during LCP procedure. If on the other hand resource r2 immediately follows resource r1, or with a gap up to a first predefined gap duration that is sufficiently short that no new LBT procedure needs to be undergone for the transmission in resource r2, then the UE shall not map high priority data for the transmission in resource r1. According to this embodiment, the UE decides autonomously based on its knowledge of whether LBT is required for transmission in resource r2 due to gap whether the new mapping behavior, e.g., not mapping higher priority data to a TB, is applied or not.

In an embodiment related to the above embodiments, if the UE does not map the high priority data to the first PUSCH allocation immediately following a CCA/LBT procedure, the UE is not required to drop a UL transmission (e.g., with a lower priority than that of the high priority data), which would have overlapped with the first PUSCH allocation.

In an embodiment related to the above embodiments, the UE does not map high priority data to the first PUSCH allocation immediately following a CCA/LBT procedure if the UE has a lower priority data (or other UL/SL transmissions) to be transmitted in the first PUSCH allocation.

In an embodiment related to the above embodiments, the UE does not map high priority data to the first PUSCH allocation immediately following a CCA/LBT procedure if the first PUSCH allocation consists of a number of symbols that is smaller than a threshold. In an example, the threshold is signaled via higher layers or a physical layer, depends on UE processing such as processing capability 1 or 2, e.g., as defined in TS38.214. In an example, the threshold is signaled in the DCI scheduling the high priority PUSCH transmission.

In an embodiment related to the above embodiments, the UE does not map high priority data to the first PUSCH allocation immediately following a CCA/LBT procedure if the first PUSCH allocation consists of a number of symbols that is larger than a threshold. In an example, the threshold is specified in 3GPP specifications (e.g., large enough to accommodate multiple non-overlapping LBTs or large enough that at least two LBTs can be performed such that the LBT failure event for them can be assumed independent with a high probability).

According to one further embodiment, the UE considers for cases that a CG PUSCH immediately follows a CCA/LBT, during HARQ process selection the priority of the data to be transmitted on the CG PUSCH resource. According to one implementation of the embodiment, the MAC entity shall prioritize between initial transmissions and retransmissions on a CG based on the priority of the data when there is some retransmission pending. For Rel-16, for example, it has been specified for NR-U that the UE shall prioritize retransmissions over initial transmissions.

According to TS 38.321 Section 5.4.1, for configured uplink grants configured with cg-RetransmissionTimer, the UE implementation selects an HARQ Process ID among the HARQ process IDs available for the configured grant configuration. The UE shall prioritize retransmissions before initial transmissions.

However, if the principle is directly applied, it could happen that a high priority autonomous retransmission is delayed due to a LBT failure when the HARQ process associated with the high priority autonomous retransmission is selected for the CG PUSCH occasion immediately following a CCA/LBT procedure, which may not be acceptable from the performance perspective (e.g., QoS requirements) of high priority traffic. Therefore, when performing HARQ process selection for a CG PUSCH transmission, UE/MAC entity shall consider the priority of the data as well as the factor whether the CG PUSCH is immediately following a CCA/LBT procedure. To be more specific, for cases when a retransmission opportunity, e.g., configured uplink grant, for an autonomous retransmission collides with some initial transmission, the UE should compare the priority of the two colliding UL transmissions and choose the higher priority uplink transmission for further processing/transmission if the CG PUSCH resource is not immediately following a CCA/LBT procedure.

However, if the CG PUSCH resource is immediately following a CCA/LBT procedure, the UE should rather transmit the lower priority uplink transmission, e.g., postpone a high priority autonomous retransmission to a subsequent CG PUSCH allocation. For cases that the CG PUSCH resource is not immediately following a CCA/LBT procedure, the UE shall select a HARQ process according to the priority of the data/UL transmission. The priority of the UL transmission may be determined based on the rules specified in Rel-16 for industrial internet of things (“IIOT”).

According to TS38.321 Section 5.4.1, for the MAC entity configured with lch-basedPrioritization, priority of an uplink grant is determined by the highest priority among priorities of the logical channels that are multiplexed (e.g., the MAC PDU to transmit is already stored in the HARQ buffer) or have data available that can be multiplexed (i.e. the MAC PDU to transmit is not stored in the HARQ buffer) in the MAC PDU, according to the mapping restrictions as described in clause 5.4.3.1.2.

According to another embodiment, the UE is configured whether it is allowed to apply different LCP restriction configurations, e.g., mapping of high priority data of LCH(s)/MAC CE(s) to PUSCH resources, for UL transmissions immediately following a CCA/LBT procedure. Such configuration may be done by higher layer signaling such as RRC signaling.

According to a further embodiment, the UE is configured whether it is allowed to change LCP restrictions rules for the first PUSCH transmission immediately following a CCA/LBT procedure for different use cases, e.g., when COT initiator changes or when gaps between CG transmissions occurring or for the case of COT sharing (Case 3). According to one implementation of this embodiment, the network configures, for example, the UE such that the UE is allowed to change the LCH restrictions and not map high priority data for a first PUSCH transmission immediately following a CCA/LBT for cases when the LBT is necessary due to a COT initiator change.

According to a further embodiment, the UE performs an autonomous retransmission in a subsequent consecutive CG PUSCH resource thereby ignoring the CGRT (configuredgrantReTxtransmission timer). Accordingly, in one implementation of this embodiment, the UE is only allowed to perform an autonomous retransmission on a consecutive CG PUSCH allocation and ignore the CGRT value if the priority of the data contained in the TB is above a preconfigured threshold. The assumption for this embodiment is that the UE has been allocated with multiple consecutive CG PUSCH resources having the same transport block size (“TBS”). Further, the assumption is that UE applies the legacy LCP procedure for the generation of a TB. Accordingly, it may happen that LBT failure occurs for the first CG PUSCH transmission of the set of consecutive CG PUSCH transmissions. Since high-priority data may be contained in the TB generated for the first CG PUSCH transmission according to legacy LCP procedure, the UE shall be allowed, according to this embodiment, to autonomously retransmit the generated TB in the immediately following CG PUSCH, e.g., second CG PUSCH allocation. Thereby, the UE ignores the CGRT value and considers the CGRT as expired, e.g., not running. This embodiment achieves a similar behavior as for the case of multi-PUSCH grant which was agreed for Rel-16.

NOTE: When a single DCI is used to schedule multiple PUSCH, the UE is allowed to map generated TB(s) internally to different HARQ processes in case of LBT failure(s), e.g., the UE may transmit a new TB on any HARQ process in the grants that have the same TBS, the same RV and the new data indicators (“NDIs”) indicate new transmission.

In an embodiment, the UE may map high-priority data to the first x UL resource(s)/PUSCH allocation(s) during LCP procedure immediately following a CCA/LBT procedure (e.g., scenarioA). However, the RV sequence/pattern to be applied to the repetitions of the high priority data (TB) is/can be different than that of the case where high priority data is not mapped to the first x UL resource(s)/PUSCH allocations during LCP procedure immediately following a CCA/LBT procedure (e.g., scenarioB). In an example, the RV pattern for case 1 is 0000, whereas for case 2 the RV pattern is 0303. The different RV patterns (for scenarioA and scenarioB) can be configured via higher layers (e.g., RRC message/signaling) or one of them can be derived from the other one (e.g., via a mapping) or one of them can be fixed/specified in 3GPP specifications e.g., scenarioA).

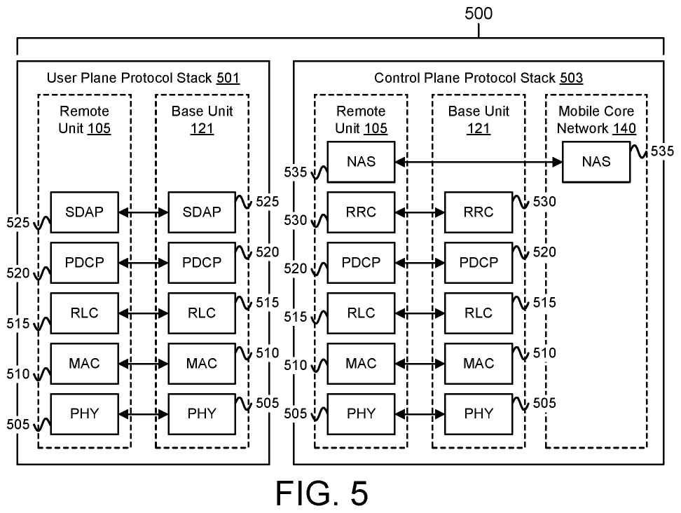

FIG. 5 depicts a NR protocol stack 500, according to embodiments of the disclosure. While FIG. 5 shows the remote unit 105, the base unit 121 and the mobile core network 130, these are representative of a set of UEs interacting with a RAN node and a NF (e.g., AMF) in a core network. As depicted, the protocol stack 500 comprises a User Plane protocol stack 501 and a Control Plane protocol stack 503. The User Plane protocol stack 501 includes a physical (“PHY”) layer 505, a MAC sublayer 510, a Radio Link Control (“RLC”) sublayer 515, a Packet Data Convergence Protocol (“PDCP”) sublayer 520, and Service Data Adaptation Protocol (“SDAP”) layer 525. The Control Plane protocol stack 503 also includes a physical layer 505, a MAC sublayer 510, a RLC sublayer 515, and a PDCP sublayer 520. The Control Place protocol stack 503 also includes a Radio Resource Control (“RRC”) layer 530 and a Non-Access Stratum (“NAS”) layer 535.

The AS protocol stack for the Control Plane protocol stack 503 consists of at least RRC, PDCP, RLC and MAC sublayers, and the physical layer. The AS protocol stack for the User Plane protocol stack 501 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 530 and the NAS layer 535 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 505 offers transport channels to the MAC sublayer 510. The MAC sublayer 510 offers logical channels to the RLC sublayer 515. The RLC sublayer 515 offers RLC channels to the PDCP sublayer 520. The PDCP sublayer 520 offers radio bearers to the SDAP sublayer 525 and/or RRC layer 530. The SDAP sublayer 525 offers QoS flows to the mobile core network 130 (e.g., 5 GC). The RRC layer 530 provides for the addition, modification, and release of Carrier Aggregation and/or Dual Connectivity. The RRC layer 530 also manages the establishment, configuration, maintenance, and release of Signaling Radio Bearers (“SRBs”) and Data Radio Bearers (“DRBs”). In certain embodiments, a RRC entity functions for detection of and recovery from radio link failure.

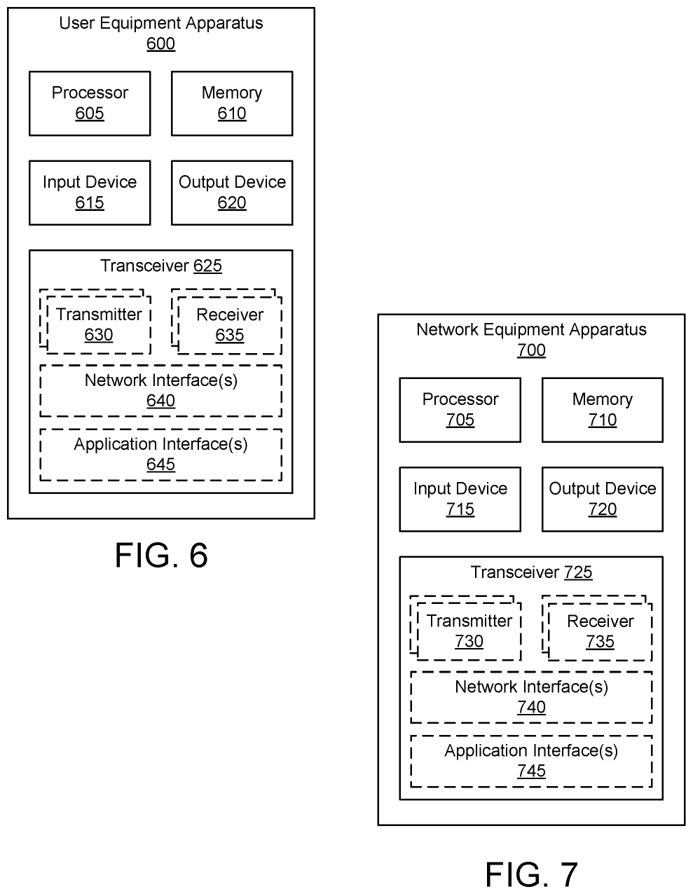

FIG. 6 depicts a user equipment apparatus 600 that may be used for logical channel restriction for PUSCH transmissions, according to embodiments of the disclosure. In various embodiments, the user equipment apparatus 600 is used to implement one or more of the solutions described above. The user equipment apparatus 600 may be one embodiment of a UE, such as the remote unit 105 and/or the UE 205, as described above. Furthermore, the user equipment apparatus 600 may include a processor 605, a memory 610, an input device 615, an output device 620, and a transceiver 625. In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more base units 121. Additionally, the transceiver 625 may support at least one network interface 640 and/or application interface 645. The application interface(s) 645 may support one or more APIs. The network interface(s) 640 may support 3GPP reference points, such as Uu and PC5. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625. In certain embodiments, the processor 605 may include an application processor (also known as “main processor”) which manages application-domain and operating system (“OS”) functions and a baseband processor (also known as “baseband radio processor”) which manages radio functions.

In various embodiments, the processor 605 controls the user equipment apparatus 600 to implement the above described UE behaviors for logical channel restriction for PUSCH transmissions.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to CSI enhancements for higher frequencies. For example, the memory 610 may store parameters, configurations, resource assignments, policies, and the like as described above. In certain embodiments, the memory 610 also stores program code and related data, such as an operating system or other controller algorithms operating on the user equipment apparatus 600, and one or more software applications.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all, or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. The transceiver 625 may be used to provide UL communication signals to a base unit 121 and to receive DL communication signals from the base unit 121, as described herein. Similarly, the transceiver 625 may be used to transmit and receive SL signals (e.g., V2X communication), as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an ASIC, or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

In one embodiment, the processor 605 receives, from a network, a set of consecutive PUSCH resource allocations and generates MAC PDUs according to the received set of consecutive PUSCH resource allocations by applying a first logical channel restriction configuration during a LCP procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

In one embodiment, the first subset of consecutive PUSCH resource allocations begins with a first PUSCH resource allocation of the set of consecutive PUSCH resource allocations.

In one embodiment, the second subset of consecutive PUSCH resource allocations comprises PUSCH resource allocations of the set of consecutive PUSCH resource allocations that are not included in the first subset of consecutive PUSCH resource allocations.

In one embodiment, the processor 605 is configured to cause the apparatus to perform a LBT procedure before a first PUSCH resource allocation of the set of consecutive PUSCH resource allocations.

In one embodiment, the processor 605 is configured to cause the apparatus to prevent mapping high priority data to one or more PUSCH resource allocations of the set of consecutive PUSCH resource allocations during the LCP procedure immediately following the LBT procedure.

In one embodiment, the processor 605 is configured to cause the apparatus to prevent mapping high priority data to one or more PUSCH resource allocations of the set of consecutive PUSCH resource allocations immediately following the LBT procedure in response to determining that at least one PUSCH resource allocation is available for transmission immediately after the first PUSCH resource allocation.

In one embodiment, the processor 605 is configured to cause the apparatus to prevent mapping high priority data to one or more PUSCH resource allocations of the set of consecutive PUSCH resource allocations immediately following the LBT procedure in response to low priority data being transmitted in the first PUSCH resource allocation of the set of consecutive PUSCH resource allocations.

In one embodiment, the processor 605 is configured to cause the apparatus to prevent multiplexing MAC CEs to one or more PUSCH resource allocations of the set of consecutive PUSCH resource allocations immediately following the LBT procedure.

In one embodiment, the processor 605 is configured to cause the apparatus to prevent multiplexing data of LCHs that have an LCH priority that is higher than a predetermined threshold to one or more PUSCH resource allocations of the set of consecutive PUSCH resource allocations immediately following the LBT procedure.

In one embodiment, the predetermined threshold for the LCH priority is at least one of preconfigured by higher-layer signalling or determined according to specification.

In one embodiment, the processor 605 is configured to cause the apparatus to, in response to a CG PUSCH resource immediately following the LBT procedure, consider a priority of data to be transmitted on the CG PUSCH resource during a HARQ process selection and postpone an autonomous retransmission of high priority data and instead transmit an initial transmission of lower priority data.

In one embodiment, the processor 605 is configured to cause the apparatus to determine whether different LCP restriction configurations are applicable to the apparatus for PUSCH transmissions that immediately follow the LBT procedure.

In one embodiment, the processor 605 is configured to cause the apparatus to determine whether LCP restriction rules for the first PUSCH transmission immediately following the LBT procedure can be modified for different use cases.

In one embodiment, a RV sequence to be applied to repetitions of high priority data is different than that of high priority data that is not mapped to the first subset of consecutive PUSCH resource allocations of the set of consecutive PUSCH resource allocations during the LCP procedure immediately following the LBT procedure.

In one embodiment, the processor 605 is configured to cause the apparatus to ignore a CG retransmission timer and autonomously retransmit a generated TB in an immediately subsequent CG PUSCH.

FIG. 7 depicts one embodiment of a network apparatus 700 that may be used for logical channel restriction for PUSCH transmissions, according to embodiments of the disclosure. In some embodiments, the network apparatus 700 may be one embodiment of a RAN node and its supporting hardware, such as the base unit 121 and/or gNB, described above. Furthermore, network apparatus 700 may include a processor 705, a memory 710, an input device 715, an output device 720, and a transceiver 725. In certain embodiments, the network apparatus 700 does not include any input device 715 and/or output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2, N3, N5, N6 and/or N7 interfaces. Other network interfaces 740 may be supported, as understood by one of ordinary skill in the art.

When implementing an NEF, the network interface(s) 740 may include an interface for communicating with an application function (i.e., N5) and with at least one network function (e.g., UDR, SFC function, UPF) in a mobile communication network, such as the mobile core network 130.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725. In certain embodiments, the processor 705 may include an application processor (also known as “main processor”) which manages application-domain and operating system (“OS”) functions and a baseband processor (also known as “baseband radio processor”) which manages radio function. In various embodiments, the processor 705 controls the network apparatus 700 to implement the above described network entity behaviors (e.g., of the gNB) for logical channel restriction for PUSCH transmissions.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data relating to CSI enhancements for higher frequencies. For example, the memory 710 may store parameters, configurations, resource assignments, policies, and the like as described above. In certain embodiments, the memory 710 also stores program code and related data, such as an operating system (“OS”) or other controller algorithms operating on the network apparatus 700, and one or more software applications.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, may include any known electronically controllable display or display device. The output device 720 may be designed to output visual, audible, and/or haptic signals. In some embodiments, the output device 720 includes an electronic display capable of outputting visual data to a user. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all, or portions of the output device 720 may be integrated with the input device 715. For example, the input device 715 and output device 720 may form a touchscreen or similar touch-sensitive display. In other embodiments, all, or portions of the output device 720 may be located near the input device 715.

As discussed above, the transceiver 725 may communicate with one or more remote units and/or with one or more interworking functions that provide access to one or more PLMNs. The transceiver 725 may also communicate with one or more network functions (e.g., in the mobile core network 80). The transceiver 725 operates under the control of the processor 705 to transmit messages, data, and other signals and also to receive messages, data, and other signals. For example, the processor 705 may selectively activate the transceiver (or portions thereof) at particular times in order to send and receive messages.

The transceiver 725 may include one or more transmitters 730 and one or more receivers 735. In certain embodiments, the one or more transmitters 730 and/or the one or more receivers 735 may share transceiver hardware and/or circuitry. For example, the one or more transmitters 730 and/or the one or more receivers 735 may share antenna(s), antenna tuner(s), amplifier(s), filter(s), oscillator(s), mixer(s), modulator/demodulator(s), power supply, and the like. In one embodiment, the transceiver 725 implements multiple logical transceivers using different communication protocols or protocol stacks, while using common physical hardware.

In one embodiment, the processor 705 transmits, to a UE, a set of consecutive PUSCH resource allocations and receives, from the UE, MAC PDUs that are generated according to the received set of consecutive PUSCH resource allocations by applying a first logical channel restriction configuration during a LCP procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

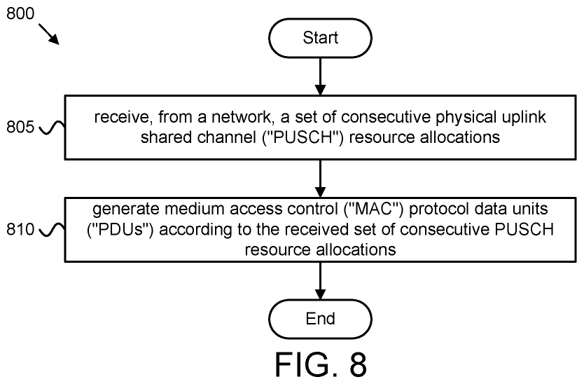

FIG. 8 is a flowchart diagram of a method 800 for logical channel restriction for PUSCH transmissions. The method 800 may be performed by a UE as described herein, for example, the remote unit 105 and/or the user equipment apparatus 600. In some embodiments, the method 800 may be performed by a processor executing program code, for example, a microcontroller, a microprocessor, a CPU, a GPU, an auxiliary processing unit, a FPGA, or the like.

The method 800 begins and receives 805, from a network, a set of consecutive PUSCH resource allocations. The method 800 generates 810 MAC PDUs according to the received set of consecutive PUSCH resource allocations. The method 800 ends.

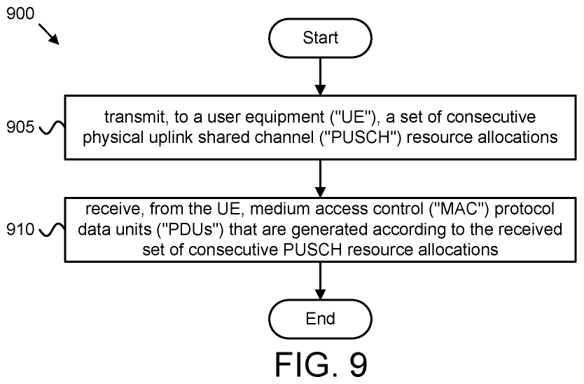

FIG. 9 is a flowchart diagram of a method 900 for logical channel restriction for PUSCH transmissions. The method 900 may be performed by a network device as described herein, for example, the base unit 121, a gNB, and/or the network equipment apparatus 700. In some embodiments, the method 900 may be performed by a processor executing program code, for example, a microcontroller, a microprocessor, a CPU, a GPU, an auxiliary processing unit, a FPGA, or the like.

The method 900 begins and transmits 905, to a UE, a set of consecutive PUSCH resource allocations. The method 900 receives 910, from the UE, MAC PDUs that are generated according to the received set of consecutive PUSCH resource allocations. The method 900 ends.

A first apparatus is disclosed for logical channel restriction for PUSCH transmissions. The first apparatus may include a UE as described herein, for example, the remote unit 105 and/or the user equipment apparatus 600. In some embodiments, the first apparatus may include a processor executing program code, for example, a microcontroller, a microprocessor, a CPU, a GPU, an auxiliary processing unit, a FPGA, or the like.

In one embodiment, the first apparatus includes a transceiver and a processor coupled to the transceiver, the processor configured to cause the apparatus to receive, from a network, a set of consecutive PUSCH resource allocations and generate MAC PDUs according to the received set of consecutive PUSCH resource allocations by applying a first logical channel restriction configuration during a LCP procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

In one embodiment, the first subset of consecutive PUSCH resource allocations begins with a first PUSCH resource allocation of the set of consecutive PUSCH resource allocations.

In one embodiment, the second subset of consecutive PUSCH resource allocations comprises PUSCH resource allocations of the set of consecutive PUSCH resource allocations that are not included in the first subset of consecutive PUSCH resource allocations.

In one embodiment, the processor is configured to cause the apparatus to perform a LBT procedure before a first PUSCH resource allocation of the set of consecutive PUSCH resource allocations.

In one embodiment, the processor is configured to cause the apparatus to prevent mapping high priority data to one or more PUSCH resource allocations of the set of consecutive PUSCH resource allocations during the LCP procedure immediately following the LBT procedure.

In one embodiment, the processor is configured to cause the apparatus to prevent mapping high priority data to one or more PUSCH resource allocations of the set of consecutive PUSCH resource allocations immediately following the LBT procedure in response to determining that at least one PUSCH resource allocation is available for transmission immediately after the first PUSCH resource allocation.

In one embodiment, the processor is configured to cause the apparatus to prevent mapping high priority data to one or more PUSCH resource allocations of the set of consecutive PUSCH resource allocations immediately following the LBT procedure in response to low priority data being transmitted in the first PUSCH resource allocation of the set of consecutive PUSCH resource allocations.

In one embodiment, the processor is configured to cause the apparatus to prevent multiplexing MAC CEs to one or more PUSCH resource allocations of the set of consecutive PUSCH resource allocations immediately following the LBT procedure.

In one embodiment, the processor is configured to cause the apparatus to prevent multiplexing data of LCHs that have an LCH priority that is higher than a predetermined threshold to one or more PUSCH resource allocations of the set of consecutive PUSCH resource allocations immediately following the LBT procedure.

In one embodiment, the predetermined threshold for the LCH priority is at least one of preconfigured by higher-layer signalling or determined according to specification.

In one embodiment, the processor is configured to cause the apparatus to, in response to a CG PUSCH resource immediately following the LBT procedure, consider a priority of data to be transmitted on the CG PUSCH resource during a HARQ process selection and postpone an autonomous retransmission of high priority data and instead transmit an initial transmission of lower priority data.

In one embodiment, the processor is configured to cause the apparatus to determine whether different LCP restriction configurations are applicable to the apparatus for PUSCH transmissions that immediately follow the LBT procedure.

In one embodiment, the processor is configured to cause the apparatus to determine whether LCP restriction rules for the first PUSCH transmission immediately following the LBT procedure can be modified for different use cases.

In one embodiment, a RV sequence to be applied to repetitions of high priority data is different than that of high priority data that is not mapped to the first subset of consecutive PUSCH resource allocations of the set of consecutive PUSCH resource allocations during the LCP procedure immediately following the LBT procedure.

In one embodiment, the processor is configured to cause the apparatus to ignore a CG retransmission timer and autonomously retransmit a generated TB in an immediately subsequent CG PUSCH.

A first method is disclosed for logical channel restriction for PUSCH transmissions. The first method may be performed by a UE as described herein, for example, the remote unit 105 and/or the user equipment apparatus 600. In some embodiments, the first method may be performed by a processor executing program code, for example, a microcontroller, a microprocessor, a CPU, a GPU, an auxiliary processing unit, a FPGA, or the like.

In one embodiment, the first method receives, from a network, a set of consecutive PUSCH resource allocations and generates MAC PDUs according to the received set of consecutive PUSCH resource allocations by applying a first logical channel restriction configuration during a LCP procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

In one embodiment, the first subset of consecutive PUSCH resource allocations begins with a first PUSCH resource allocation of the set of consecutive PUSCH resource allocations.

In one embodiment, the second subset of consecutive PUSCH resource allocations comprises PUSCH resource allocations of the set of consecutive PUSCH resource allocations that are not included in the first subset of consecutive PUSCH resource allocations.

In one embodiment, the first method performs a LBT procedure before a first PUSCH resource allocation of the set of consecutive PUSCH resource allocations.

In one embodiment, the first method prevents mapping high priority data to one or more PUSCH resource allocations of the set of consecutive PUSCH resource allocations during the LCP procedure immediately following the LBT procedure.

In one embodiment, the first method prevents mapping high priority data to one or more PUSCH resource allocations of the set of consecutive PUSCH resource allocations immediately following the LBT procedure in response to determining that at least one PUSCH resource allocation is available for transmission immediately after the first PUSCH resource allocation.

In one embodiment, the first method prevents mapping high priority data to one or more PUSCH resource allocations of the set of consecutive PUSCH resource allocations immediately following the LBT procedure in response to low priority data being transmitted in the first PUSCH resource allocation of the set of consecutive PUSCH resource allocations.

In one embodiment, the first method prevents multiplexing MAC CEs to one or more PUSCH resource allocations of the set of consecutive PUSCH resource allocations immediately following the LBT procedure.

In one embodiment, the first method prevents multiplexing data of LCHs that have an LCH priority that is higher than a predetermined threshold to one or more PUSCH resource allocations of the set of consecutive PUSCH resource allocations immediately following the LBT procedure.

In one embodiment, the predetermined threshold for the LCH priority is at least one of preconfigured by higher-layer signalling or determined according to specification.

In one embodiment, the first method, in response to a CG PUSCH resource immediately following the LBT procedure, considers a priority of data to be transmitted on the CG PUSCH resource during a HARQ process selection and postpone an autonomous retransmission of high priority data and instead transmit an initial transmission of lower priority data.

In one embodiment, the first method determines whether different LCP restriction configurations are applicable to the apparatus for PUSCH transmissions that immediately follow the LBT procedure.

In one embodiment, the first method determines whether LCP restriction rules for the first PUSCH transmission immediately following the LBT procedure can be modified for different use cases.

In one embodiment, a RV sequence to be applied to repetitions of high priority data is different than that of high priority data that is not mapped to the first subset of consecutive PUSCH resource allocations of the set of consecutive PUSCH resource allocations during the LCP procedure immediately following the LBT procedure.

In one embodiment, the first method ignores a CG retransmission timer and autonomously retransmit a generated TB in an immediately subsequent CG PUSCH.

A second apparatus is disclosed for logical channel restriction for PUSCH transmissions. The second apparatus includes a network device as described herein, for example, the base unit 121, a gNB, and/or the network equipment apparatus 700. In some embodiments, the second apparatus includes a processor executing program code, for example, a microcontroller, a microprocessor, a CPU, a GPU, an auxiliary processing unit, a FPGA, or the like.

In one embodiment, the second apparatus includes a transceiver and a processor coupled to the transceiver, the processor configured to cause the apparatus to transmit, to a UE, a set of consecutive PUSCH resource allocations and receive, from the UE, MAC PDUs that are generated according to the received set of consecutive PUSCH resource allocations by applying a first logical channel restriction configuration during a LCP procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

A second method is disclosed for logical channel restriction for PUSCH transmissions. The second method may be performed by a network device as described herein, for example, the base unit 121, a gNB, and/or the network equipment apparatus 700. In some embodiments, the second method may be performed by a processor executing program code, for example, a microcontroller, a microprocessor, a CPU, a GPU, an auxiliary processing unit, a FPGA, or the like.

In one embodiment, the second method transmits, to a UE, a set of consecutive PUSCH resource allocations and receives, from the UE, MAC PDUs that are generated according to the received set of consecutive PUSCH resource allocations by applying a first logical channel restriction configuration during a LCP procedure for generation of a first set of MAC PDUs associated with a first subset of consecutive PUSCH resource allocations of the set of consecutive PUSCH resource allocations and applying a second logical channel restriction configuration for generation of a second set of MAC PDUs associated with a second subset of consecutive PUSCH resource allocations of the set of consecutive PUSCH resource allocations.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a transceiver; and
a processor coupled to the transceiver, the processor configured to cause the apparatus to:
receive, from a network, a set of consecutive physical uplink shared channel (“PUSCH”) resource allocations;
generate medium access control (“MAC”) protocol data units (“PDUs”) according to the received set of consecutive PUSCH resource allocations by:
applying a first logical channel restriction configuration during a logical channel prioritization (“LCP”) procedure for generation of a first set of MAC PDUs associated with a first subset of consecutive PUSCH resource allocations of the set of consecutive PUSCH resource allocations; and
applying a second logical channel restriction configuration for generation of a second set of MAC PDUs associated with a second subset of consecutive PUSCH resource allocations of the set of consecutive PUSCH resource allocations.

2. The apparatus of claim 1, wherein the first subset of consecutive PUSCH resource allocations begins with a first PUSCH resource allocation of the set of consecutive PUSCH resource allocations.

3. The apparatus of claim 1, wherein the second subset of consecutive PUSCH resource allocations comprises PUSCH resource allocations of the set of consecutive PUSCH resource allocations that are not included in the first subset of consecutive PUSCH resource allocations.

4. The apparatus of claim 1, wherein the processor is configured to cause the apparatus to perform a listen before talk (“LBT”) procedure before a first PUSCH resource allocation of the set of consecutive PUSCH resource allocations.

5. The apparatus of claim 4, wherein the processor is configured to cause the apparatus to prevent mapping high priority data to one or more PUSCH resource allocations of the set of consecutive PUSCH resource allocations during the LCP procedure immediately following the LBT procedure.

6. The apparatus of claim 5, wherein the processor is configured to cause the apparatus to prevent mapping high priority data to one or more PUSCH resource allocations of the set of consecutive PUSCH resource allocations immediately following the LBT procedure in response to determining that at least one PUSCH resource allocation is available for transmission immediately after the first PUSCH resource allocation.

7. The apparatus of claim 5, wherein the processor is configured to cause the apparatus to prevent mapping high priority data to one or more PUSCH resource allocations of the set of consecutive PUSCH resource allocations immediately following the LBT procedure in response to low priority data being transmitted in the first PUSCH resource allocation of the set of consecutive PUSCH resource allocations.

8. The apparatus of claim 4, wherein the processor is configured to cause the apparatus to prevent multiplexing MAC control elements (“CEs”) to one or more PUSCH resource allocations of the set of consecutive PUSCH resource allocations immediately following the LBT procedure.

9. The apparatus of claim 4, wherein the processor is configured to cause the apparatus to prevent multiplexing data of logical channels (“LCHs”) that have an LCH priority that is higher than a predetermined threshold to one or more PUSCH resource allocations of the set of consecutive PUSCH resource allocations immediately following the LBT procedure.

10. The apparatus of claim 7, wherein the predetermined threshold for the LCH priority is at least one of preconfigured by higher-layer signalling or determined according to specification.

11. The apparatus of claim 4, wherein the processor is configured to cause the apparatus to, in response to a configured grant (“CG”) PUSCH resource immediately following the LBT procedure, consider a priority of data to be transmitted on the CG PUSCH resource during a hybrid automatic repeat request (“HARQ”) process selection and postpone an autonomous retransmission of high priority data and instead transmit an initial transmission of lower priority data.

12. The apparatus of claim 4, wherein a redundancy version (“RV”) sequence to be applied to repetitions of high priority data is different than that of high priority data that is not mapped to the first subset of consecutive PUSCH resource allocations of the set of consecutive PUSCH resource allocations during the LCP procedure immediately following the LBT procedure.

13. The apparatus of claim 1, wherein the processor is configured to cause the apparatus to ignore a configured grant (“CG”) retransmission timer and autonomously retransmit a generated transport block (“TB”) in an immediately subsequent CG PUSCH.

14. A method, comprising:
receiving, from a network, a set of consecutive physical uplink shared channel (“PUSCH”) resource allocations;
generating medium access control (“MAC”) protocol data units (“PDUs”) according to the received set of consecutive PUSCH resource allocations by:
applying a first logical channel restriction configuration during a logical channel prioritization (“LCP”) procedure for generation of a first set of MAC PDUs associated with a first subset of consecutive PUSCH resource allocations of the set of consecutive PUSCH resource allocations; and
applying a second logical channel restriction configuration for generation of a second set of MAC PDUs associated with a second subset of consecutive PUSCH resource allocations of the set of consecutive PUSCH resource allocations.

15. An apparatus, comprising:
a transceiver; and
a processor coupled to the transceiver, the processor configured to cause the apparatus to:
transmit, to a user equipment (“UE”), a set of consecutive physical uplink shared channel (“PUSCH”) resource allocations; and
receive, from the UE, medium access control (“MAC”) protocol data units (“PDUs”) that are generated according to the received set of consecutive PUSCH resource allocations by:
applying a first logical channel restriction configuration during a logical channel prioritization (“LCP”) procedure for generation of a first set of MAC PDUs associated with a first subset of consecutive PUSCH resource allocations of the set of consecutive PUSCH resource allocations; and
applying a second logical channel restriction configuration for generation of a second set of MAC PDUs associated with a second subset of consecutive PUSCH resource allocations of the set of consecutive PUSCH resource allocations.
